(19) United States
(12) Patent Application Publication
(10) Pub. No.: US 2026/0274294 A1
(43) Pub. Date: Sep. 17, 2026

(54) VEHICLE CONTROL SYSTEM AND METHOD USING COLLABORATIVE DRIVING TECHNOLOGY

(71) Applicants: HON HAI PRECISION INDUSTRY CO., LTD., New Taipei City (TW); Foxconn Technology Group Co., Ltd., Guangdong Province (CN)

(72) Inventors: Yung-Hui LI, New Taipei City (TW); Nien-Yi JAN, New Taipei City (TW); Kai-Lin YANG, New Taipei City (TW); Yi-Rong LIN, New Taipei City (TW); Linfeng ZHENG, New Taipei City (TW); Shiqi WANG, New Taipei City (TW)

(21) Appl. No.: 19/564,242

(22) Filed: Mar. 12, 2026

Related U.S. Application Data
(60) Provisional application No. 63/770,964, filed on Mar. 12, 2025.

(51) Int. Cl. B60W 60/00; B60W 10/04; B60W 10/18; B60W 10/20; G01S 17/931

(52) U.S. Cl. CPC B60W 60/001; B60W 10/04; B60W 10/18; B60W 10/20; G01S 17/931; B60W 2556/45

(57) ABSTRACT

A vehicle control system and method using collaborative driving technology are provided. The system includes a sensing device, a communication circuit and a control circuit. The sensing circuit is configured to provide sensing data of a user's vehicle. The communication circuit is configured to receive compressed data of vehicles surrounding the user's vehicle. The control circuit is configured to receive the sensing data and the compressed data, and control the user's vehicle. In another embodiment, the system includes driving-oriented feature encoder circuits. A multi view feature joint decoder circuit and a control circuit. The method includes: compressing driving-oriented feature data by using the encoder circuit to obtain compressed data; decompressing the compressed data and calculating fused feature data by using the decoder circuit; and inputting the fused feature data into a vehicle driving model to obtain vehicle-driving signals.

### CROSS-REFERENCE TO RELATED APPLICATIONS

This application claims priority to U.S. Provisional Application Ser. No. 63/770,964 filed Mar. 12, 2025, which is herein incorporated by reference.

### BACKGROUND

### Technical Field

The present disclosure relates to a vehicle control system and method using collaborative driving technology.

### Description of Related Art

With the advancement of technology and economic growth, various vehicle communication systems and standards have been developed to support autonomous and semi-autonomous techniques of vehicles. The vehicle communication systems and standards include communication systems and standards of vehicle-to-infrastructure (V2X) or vehicle-to-vehicle (V2V) for information exchange between vehicles and vehicles, thereby improving traffic conditions.

### SUMMARY

A vehicle control system using collaborative driving technology is provided according to the embodiments of the present disclosure, and the vehicle control system adopts a vehicle-to-vehicle (V2V) communication technology. The embodiments of the present disclosure can improve the communication bandwidth required by the communication technology mentioned above while maintaining the decision-making performance. Secondly, the embodiments of the present disclosure can support the fusion of driving-oriented features between vehicles. Furthermore, the embodiments of the present disclosure include a coordinate alignment technique and a multi view feature joint technique to provide a flexible and robust spatial feature integration.

According to the embodiments of the present disclosure, the aforementioned vehicle control system using collaborative driving technology includes: a sensing device, a communication circuit, and a control circuit. The sensing device is configured to provide a plurality of sensing data of a user's vehicle. The communication circuit is configured to receive a plurality of compressed data of a plurality of surrounding vehicles; the control circuit is electrically connected to the sensing device and the communication circuit to receive the aforementioned sensing data and compressed data and control the user's vehicle. The control circuit performs: performing a feature extraction to the aforementioned sensing data to obtain a plurality of first driving-oriented features of the user's vehicle; performing decompression to the compressed data to obtain a plurality of second driving-oriented features of surrounding vehicles; performing a feature fusion computation operation on the first driving-oriented features and the second driving-oriented features to obtain a plurality of fused features; inputting the fused feature into a vehicle driving model to obtain a plurality of vehicle-driving signals; and utilizing the vehicle-driving signals to control the user's vehicle.

In some embodiments, the aforementioned sensing device is a LIDAR, the aforementioned sensing data are point cloud date representing a Bird′ Eye View (BEV).

In some embodiments, the aforementioned vehicle-driving signals include a throttle control signal, a brake control signal, and a steering control signal.

In some embodiments, a loss function adopted by the vehicle driving model is shown below:

$${ℒ}_{control} = ( {ℒ}_{throttle} + {ℒ}_{ brake} + {L}_{steer} ) + λ \cdot ℛ$$

wherein [symbol] _{control} represents an overall control loss function of the user's vehicle, [symbol] ₜₕᵣₒₜₜₗₑ represents a throttle action loss function of the user's vehicle, [symbol] _{brake} represents a brake action loss function of the user's vehicle, [symbol] ₛₜₑₑᵣ represents a steering action loss function of the user's vehicle, [symbol] is a bitrate, λ is a bitrate balance value.

According to the embodiments of the present disclosure, the aforementioned vehicle control system using collaborative driving technology includes: a plurality of driving-oriented feature encoder circuits, a multi view feature joint decoder circuit, and a control circuit. The driving-oriented feature encoder circuits correspond to a plurality of surrounding vehicles. The driving-oriented feature encoder circuits is configured to compress a plurality of driving-oriented feature data to obtain a plurality of compressed data. The multi view feature joint decoder circuit corresponds to a user's vehicle, the multi view feature joint decoder circuit is configured to decompress the plurality of compressed data of the plurality of driving-oriented feature encoder circuits, and perform calculation to obtain a fused feature data according to the plurality of compressed data; the control circuit is configured to receive the fused feature data, and input the fused feature data into a vehicle driving model to obtain a plurality of vehicle-driving signals; a loss function adopted by the vehicle driving model is shown below:

$${ℒ}_{control} = ( {ℒ}_{throttle} + {ℒ}_{ brake} + {L}_{steer} ) + λ \cdot ℛ$$

[symbol] _{control} represents an overall control loss function of the user's vehicle, [symbol] ₜₕᵣₒₜₜₗₑ represents a throttle action loss function of the user's vehicle, [symbol] _{brake} represents a brake action loss function of the user's vehicle, [symbol] ₛₜₑₑᵣ represents a steering action loss function of the user's vehicle, [symbol] is a data bitrate corresponding to the plurality of driving-oriented feature encoder circuits, A is a bitrate balance value.

In some embodiments, the aforementioned vehicle control system using collaborative driving technology further includes: a plurality of first wireless communication circuits and a second wireless communication circuit. The first wireless communication circuits correspond to surrounding vehicles, and are electrically connected to the driving-oriented feature encoder circuits. The first wireless communication circuits are configured to receive the compressed data, and wirelessly transmit the compressed data. The second wireless communication circuit corresponds to the user's vehicle, and is electrically connected to the multi view feature joint decoder circuit. The second wireless communication circuit is configured to wirelessly receive the compressed data, and transmit the compressed data to the multi view feature joint decoder circuit.

In some embodiments, the vehicle-driving signals include a throttle control signal, a brake control signal, and a steering control signal.

According to the embodiments of the present disclosure, the aforementioned vehicle control method using collaborative driving technology includes: utilizing a plurality of driving-oriented feature encoder circuits to compress a plurality of driving-oriented feature data to obtain a plurality of compressed data; utilizing a multi view feature joint decoder circuit to decompress the plurality of compressed data of the driving-oriented feature encoder circuits, and performing calculation to obtain a fused feature data according to the compressed data and a sensing data; inputting the fused feature data into a vehicle driving model to obtain a plurality of vehicle-driving signals. A loss function adopted by the vehicle driving model is shown below:

$${ℒ}_{control} = ( {ℒ}_{throttle} + {ℒ}_{ brake} + {L}_{steer} ) + λ \cdot ℛ$$

wherein [symbol] _{control} represents an overall control loss function of the user's vehicle [symbol] ₜₕᵣₒₜₜₗₑ represents a throttle action loss function of the user's vehicle, [symbol] _{brake} represents a brake action loss function of the user's vehicle, [symbol] ₛₜₑₑᵣ represents a steering action loss function of the user's vehicle, [symbol] is a data bitrate corresponding to the driving-oriented feature encoder circuits, λ is a bitrate balance value.

In some embodiments, the aforementioned vehicle control method using collaborative driving technology further includes: utilizing a wireless approach to transmit the compressed data from the driving-oriented feature encoder circuits to a multi view feature joint decoder circuit.

In some embodiments, the vehicle-driving signals include a throttle control signal, a brake control signal, and a steering control signal.

In some embodiments, the aforementioned vehicle control method using collaborative driving technology further includes a two stage model training process to train and generate a vehicle driving model.

In some embodiments, the two stage model training process includes a first stage model training process, the first stage model training process adopts a behavior cloning method to perform training.

In some embodiments, the two stage model training process includes a second stage model training process, the second stage model training process adopts a Dataset Aggregation (DAgger) to perform training.

In some embodiments, the driving-oriented feature data corresponds to a plurality of BEV data.

In some embodiments, the BEV data are point cloud data.

### BRIEF DESCRIPTION OF THE DRAWINGS

For a more complete understanding of the present disclosure, and the advantages thereof, reference is now made to the following descriptions to be taken in conjunction with the accompanying drawings.

FIG. 1 is a schematic diagram of vehicles, illustrated in accordance with embodiments of the present disclosure.

FIG. 2 is a functional block diagram of a vehicle control system using collaborative driving technology, illustrated in accordance with embodiments of the present disclosure.

FIG. 3 is a functional block diagram of a control circuit, illustrated in accordance with some embodiments of the present disclosure.

FIG. 4 is a functional block diagram of driving-oriented feature encoder circuits and a multi view feature joint decoder circuit, illustrated in accordance with some embodiments of the present disclosure.

FIG. 5 is a flowchart diagram of a vehicle control method using collaborative driving technology, illustrated in accordance with some embodiments of the present disclosure.

### DETAILED DESCRIPTION

The following specification will be described in details in the following embodiments with reference to the accompanying drawings. However, the embodiments described are not intended to limit the scope of the disclosure. Moreover, it is not intended for the description of structure and operation to limit the order of implementation. Any device with equivalent functions that is produced from a structure formed by a recombination of elements shall fall within the scope of the disclosure. Furthermore, according to standards and regular practices in the industry, the drawings are shown only for purpose of facilitating illustration, and are not depicted according to the original scale.

The terms “first”, “second”, etc. are used herein to describe different components, these terms are used only to distinguish the elements or operations described in the same technical terms. Unless the context clearly indicates otherwise, the terms do not imply or indicate any order or sequence thereof and should not be limited by these terms.

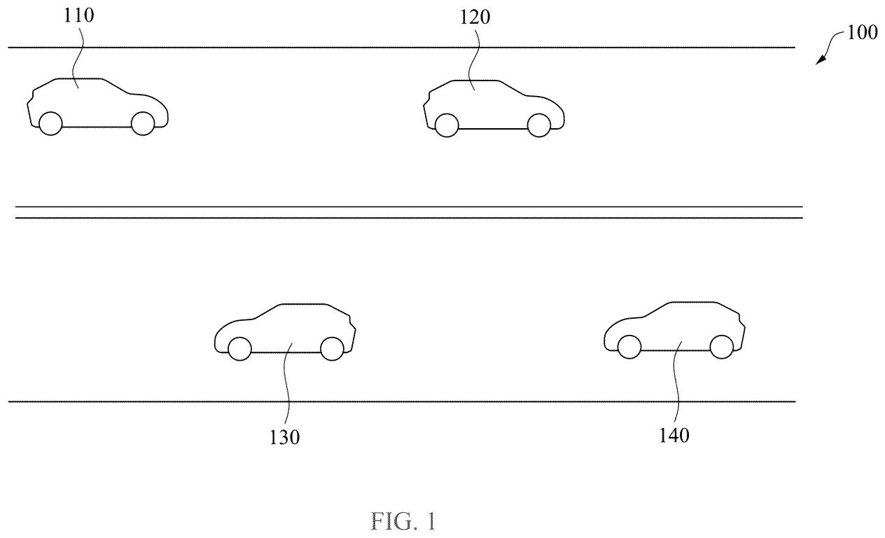

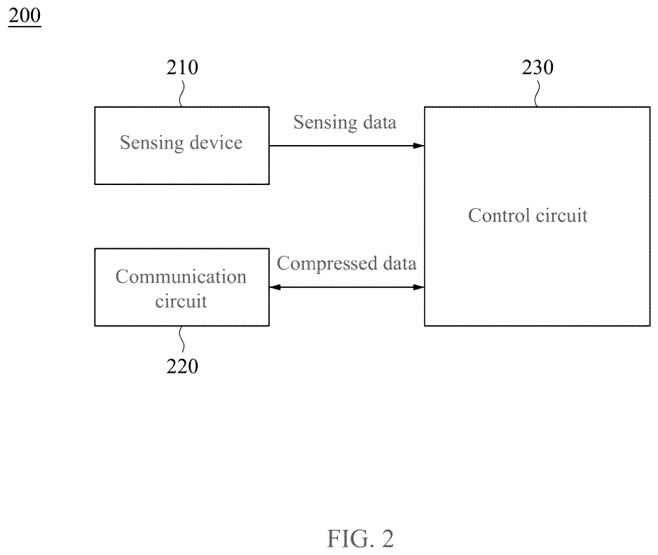

Referring to FIG. 1 and FIG. 2, FIG. 1 is a schematic diagram of vehicles, illustrated in accordance with some embodiments of the present disclosure, FIG. 2 is a functional block diagram of a vehicle control system 200 using collaborative driving technology, illustrated in accordance with embodiments of the present disclosure. As illustratively shown in FIG. 1, multiple vehicles are driving on a road 100, wherein vehicles 110, 120, 130, 140 are applied with vehicle-to-vehicle (V2V) communication technology to achieve autonomous and semi-autonomous functionalities. As illustratively shown in FIG. 2, each of the vehicles includes the vehicle control system 200 using collaborative driving technology to control the vehicles by utilizing the vehicle control system 200 using collaborative driving technology. The vehicle control system 200 using collaborative driving technology sensing device 210, a communication circuit 220, and a control circuit 230. The sensing device 210 is configured to sense surrounding objects around the vehicles to provide sensing data. In the present embodiment, the sensing device 210 is configured to provide sensing data of Bird's Eye View (BEV). The sensing device 210 can be a camera, radar, or LiDAR device, the sensing data can be point cloud data. However, the present disclosure is not limited to this. In the embodiments of the present disclosure, the point cloud data can be used to generate the BEV.

The communication circuit 220 is configured to receive or transmit data of the vehicles. For example, the vehicle 110 utilizes the communication circuit 220 to transmit the sensing data of itself to surrounding vehicles 120, 130, 140, and receive the sensing data of the surrounding vehicles 120, 130, 140 from the surrounding vehicles 120, 130, 140. For another example, the vehicle 120 utilizes the communication circuit 220 to transmit the sensing data of itself to the surrounding vehicles 110, 130, 140, and receive the sensing data of the surrounding vehicles 110, 130, 140 from the surrounding vehicles 110, 130, 140. For another example, the vehicle 130 utilizes the communication circuit 220 to transmit the sensing data of the vehicle 130 to the surrounding vehicles 110, 120, 140, and receive the sensing data of the surrounding vehicles 110, 120, 140 from the surrounding vehicles 110, 120, 140. For another example, the vehicle 140 utilizes the communication circuit 220 to transmit the sensing data of the vehicle 140 to the surrounding vehicles 110, 120, 130, and receive the sensing data of the surrounding vehicles 110, 120, 130 from the surrounding vehicles 110, 120, 130. In some embodiments, features of the sensing data can be extracted by a feature extraction operation, and the feature data is transmitted to the surrounding vehicles.

In some embodiments, the communication circuit 220 is the dedicated short-range communication (DSRC) circuit, which utilizes wireless approach to transmit data. However, the present disclosure is not limited to this. Additionally, in some embodiments, when the aforementioned vehicles transmit feature data to other vehicles, the feature data can be compressed to reduce the size of the feature data, lowering the bitrate necessary for transmitting the feature data.

The control circuit 230 is configured to receive the sensing data sensed by the sensing device 210 to receive the feature data (compressed data) of other vehicles transmitted from the communication circuit 220. The control circuit 230 can control the vehicles based on the sensing data and the compressed data mentioned above. For example, consider that the vehicle 110 is a user's vehicle, the control circuit 230 of the user's vehicle 110 performs a data feature fusion based on the sensing data of the user's vehicle 110 itself and the feature data transmitted from the surrounding vehicles 120, 130, 140 to obtain a fused feature, and inputs the fused feature to a vehicle driving model (For example a task head), and obtain vehicle-driving signals of the user's vehicle 110. Thereby, the control circuit 230 of the user's vehicle 110 is able to control the user's vehicle 110 according to the vehicle-driving signals. In some embodiments, the vehicle-driving signals mentioned above include a throttle control signal, a brake control signal, and a steering control signal, Thereby, the control circuit 230 can control the throttle, brake, and steering of the user's vehicle 110.

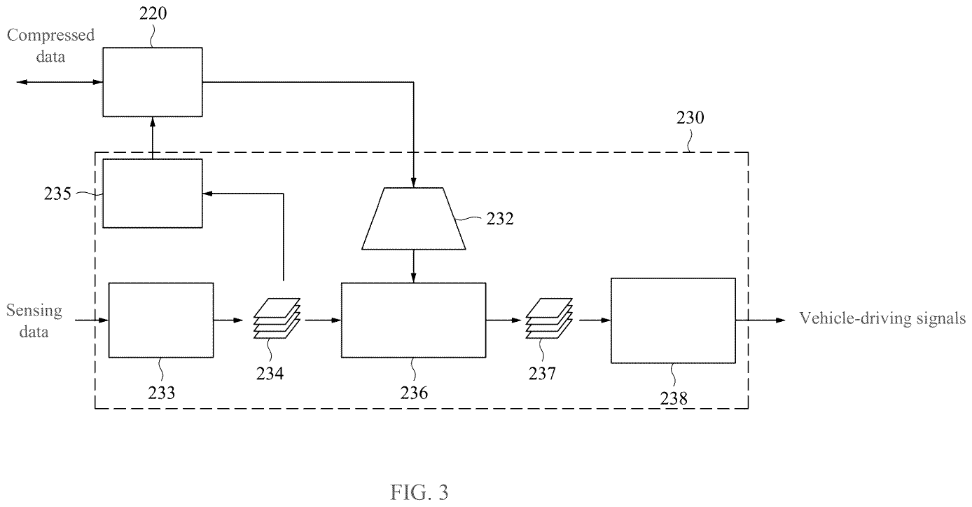

Referring to FIG. 3, FIG. 3 is a functional block diagram of the control circuit 230, illustrated in accordance with some embodiments of the present disclosure. The control circuit 230 includes a decoder 232, a feature extractor 233, an encoder 235, a multi view feature fuser 236, and a driving-oriented navigation task head 238. The decoder 232 is configured to receive the compressed data of the surrounding vehicles from the communication circuit 220 to perform a decompression operation on the compressed data, and obtain the feature data of the surrounding vehicles. In the embodiments of the present disclosure, the feature data transmitted from the surrounding vehicles can be, for example, image feature data of the BEV. The image feature data of the BEV mentioned above can represent driving-oriented features of the surrounding vehicles, for example, acceleration features, deceleration features, steering features. The feature extractor 233 is configured to receive the sensing data of the user's vehicle from the sensing device 210 and perform feature extraction to the sensing data. For example, the feature extractor 233 performs the feature extraction to the BEV data (for example, the point cloud data of the BEV) of the sensing device 210 to obtain a driving-oriented features 234 representing the user's vehicle. The encoder 235 is configured to receive the driving-oriented features 234 representing the user's vehicle to perform a data compression operation on the driving-oriented features 234. The compressed driving-oriented features 234 are transmitted to the communication circuit 220 and to be transmitted to the surrounding vehicles by utilizing the communication circuit 220.

In the embodiments of using the LiDAR device, the feature extractor 233 can process signals (for example, the point cloud data) of the LiDAR device into a unified BEV representation (that is, the aforementioned BEV image feature). Specifically, the feature extractor 233 can be composed of a columnar encoder and a 2D sparse convolutional neural networks based backbone network. The columnar encoder organizes the original point cloud data into a vertical columnar structure, and applies linear layer and maximum pooling layer to generate a preliminary BEV image feature representation. The backbone network utilizes sparse convolution to further abstractify these features, and generates downsampled intermediate BEV features.

Assume that the point cloud data is x∈R^{(n×3)}, wherein n indicates the quantity of points, 3 indicates the three-dimensional coordinate x, y, z. The feature extraction process of the feature extractor 233 can be presented as follows:

$${f}_{B E V} = Ψ ( Φ ( x ) ) ∈ {ℝ}^{H \times W \times C} \qquad ( 1 )$$

Wherein H×W is perception range, C is channel dimension.

Specifically, the columnar encoder Φ(⋅) firstly transforms the original point cloud x into the stacked columnar structure, and then re-scatters it back to a two-dimensional pseudo-image. Then, the backbone network Ψ(⋅) processes the two-dimensional pseudo-image and obtain the BEV image feature with the size of H×W×C, that is, f_{BEV}.

The multi view feature fuser 236 is configured to receive the driving-oriented features of the vehicles and the driving-oriented features of the user's vehicle to perform the feature fusion computation operation on the features mentioned above, and obtain multiple fused features. Then, the fused features are input into the driving-oriented task head 238 of the vehicle driving model to obtain the vehicle-driving signals.

In the embodiments of the present disclosure, the vehicle driving model is a network providing driving-oriented features and driving strategies, and configuring the corresponding task head 238. Specifically, the driving strategies of the present disclosure include various throttle opening levels, braking intensity, and steering amount of the vehicles. The training of the vehicle driving model adopts a two stage imitation learning training strategy. In the first stage, the vehicle driving model adopts a behavior cloning method to train a driving strategy network of the vehicle driving model, such that the driving strategy network is able to generate an appropriate driving strategy. The loss function is a linear combination of a predicted L1 loss of the throttle, brake, and steering action and expert action, as shown in the following equation:

$${ℒ}_{control} = {ℒ}_{throttle} + {ℒ}_{ brake} + {ℒ}_{steer} \qquad ( 2 )$$

Wherein [symbol] _{control} represents an overall control loss function of the user's vehicle, [symbol] ₜₕᵣₒₜₜₗₑ represents a throttle action loss function of the user's vehicle, [symbol] _{brake} represents a brake action loss function of the user's vehicle, [symbol] ₛₜₑₑᵣ represents a steering action loss function of the user's vehicle.

In the second stage, a Dataset Aggregation (DAgger) method is adopted to perform training, wherein an expert strategy interacts with the surroundings during an online training period, thereby generating abundant training data. Additionally, the embodiments of the present disclosure introduce a bitrate constraint loss to generate compact intermediate features, as shown in the following equation:

$${ℒ}_{control} = ( {ℒ}_{throttle} + {ℒ}_{ brake} + {ℒ}_{steer} ) + λ \cdot ℛ \qquad ( 3 )$$

Wherein [symbol] is a data bitrate, λ is a bitrate balance value.

In some embodiments of the present disclosure, the value of λ is from 10⁻² to 10⁻⁴. For example, in low bandwidth mode, the value of λ is 10⁻². For another example, in balance mode, the value of λ is 10⁻³. For another example, in high-fidelity mode, the value of λ is 10⁻⁴.

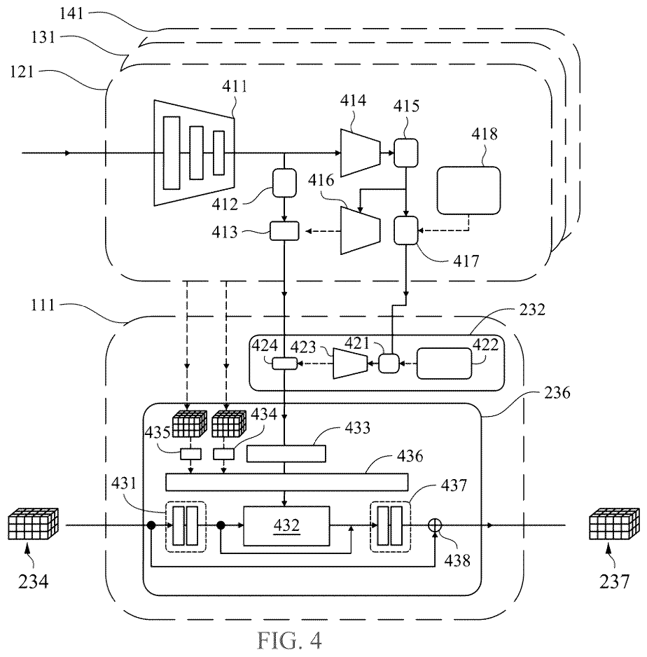

Referring to FIG. 4, FIG. 4 is a functional block diagram of driving-oriented feature encoder circuits and a multi view feature joint decoder circuit, illustrated in accordance with some embodiments of the present disclosure. As illustratively shown in FIG. 4, the multi view feature joint decoder circuit 111 is configured to receive the compressed data transmitted from the driving-oriented feature encoder circuits 121, 131, and 141. Specifically, the driving-oriented feature encoder circuits 121, 131, and 141 are encoders of the surrounding vehicles, configured to compress the feature data of the surrounding vehicles. Each of the driving-oriented feature encoder circuits 121, 131, and 141 includes: a convolutional layer computation unit 411, a quantification computation unit 412, an arithmetic encoding unit 413, a hyper-encoder 414, a quantification computation unit 415, a hyper-decoder 416, an arithmetic encoding unit 417, and a factorized prior unit 418.

The convolutional layer computation unit 411 is configured to perform the spatial feature extraction and transformation, transforming the input BEV data (that is, the aforementioned BEV image feature) representation into a more compact latent space. The quantification computation units 412, 415 are configured to transform continuous latent features into discrete values to reduce the data volume that facilitate digital data transmission. The arithmetic encoding units 413, 417 adopt the lossless entropy coding technique to utilize an estimated probability distribution to eliminate the statistic redundancy that compresses the quantified symbols into a binary bitstream. The hyper-encoder 414 and the hyper-decoder 416 construct a hyper-prior model. The hyper-encoder 414 can extract side information (spatial dependency) from the latent features, and the hyper-decoder 416 utilizes the side information to accurately estimate the probability distribution (mean value and scale) of the arithmetic encoding unit 413. The factorized prior unit 418 is configured to provide a simplified, non-conditional probability model, used to encode the information itself into bitstream.

In the embodiments of the present disclosure, a dedicated convolutional encoder ε is used to process extracted BEV image features f, generating a latent representation u=ε(f). This representation can be quantified as û= [symbol] (u), wherein the quantification function Q(⋅) in the data training process of the present disclosure utilizes an additive uniform noise n~ [symbol] (−0.5, 0.5) to perform estimation to achieve an end-to-end optimization. Because the laser radar of the LiDAR device has high sparsity, the feature encoder utilizes the residual network composed of cascaded sparse convolution layers to achieve a compact encoding of sparse features.

The quantified latent features û are compressed into bitstream through arithmetic coding. Then, a hyper-prior model composed of the hyper-encoder [symbol] ε and the hyper-decoder [symbol] D can extract a side information v from the latent representation, and estimate the probability distribution p(û|\hat{v}) of the quantified features. For example, the hyper-encoder is used to extract the side information v, the hyper-decoder is used to accurately estimate the entropy model of û under the given condition \hat{v}. The aforementioned calculation can be represented as follows:

$$v = ℋℰ ( u ) , \hat{v} = Q ( v ) , p ( \hat{u} \vert \hat{v} ) ∼ ℋ𝒟 ( \hat{v} ) \qquad ( 4 )$$

Wherein p_{û|\hat{v}}(û|\hat{v}) represents the probability of û.

Regarding the probability modeling of û, it can be performed by applying the conditional Gaussian distribution that performs convolution with uniform quantification noise, while the probability of \hat{v} can be performed with the fully, the calculation equation thereof is shown as follows:

$${p}_{\hat{u} \vert \hat{v}} ( \hat{u} \vert \hat{v} ) = {\prod }_{i} ( 𝒩 ( {μ}_{i} , {σ}_{i}^{2} ) * 𝒰 ( - 0.5 , 0.5 ) ) ( {\hat{u}}_{i} ) \qquad ( 5 )$$

$${p}_{\hat{v}} ( \hat{v} ) = {\prod }_{i} ( {p}_{{v}_{i}} * 𝒰 ( - 0.5 , 0.5 ) ) ( {\hat{v}}_{i} ) \qquad ( 6 )$$

Wherein p\hat{v}(v) represents the probability of \hat{v}; uᵢ represents the Predicted Mean, the mean value of the Gaussian distribution predicted by the hyper-decoder; σᵢ represents the Predicted Standard Deviation, the scale parameter of the Gaussian distribution predicted by the hyper-decoder; ûᵢ represents the Quantified Latent Element, each channel components of quantified features generated by the main encoder; pᵥ_{ᵢ} represents the probability density function (PDF) of side information, the non-parametric probabilistic model established to the side information v; \hat{v}ᵢ represent the Quantified Side Information Element, each channel components of the quantified side information generated by the hyper-encoder; Πᵢ is the Product Operator, indicating that multiplying each of the probability of element i, and calculating the overall joint distribution.

The aforementioned calculation enables efficient entropy coding to maximally reduce the statistic redundancy. The total bitrate [symbol] of the vehicles can be determined by the following equation:

$$ℛ = 𝔼 [ - {log}_{2} p ( \hat{u} \vert \hat{v} ) ] + 𝔼 [ - {log}_{2} p ( \hat{v} ) ] \qquad ( 7 )$$

Wherein [symbol] is an Expected Value, indicating the mean value under the probability distribution, which is used to calculate the average bitrate in the present disclosure.

Specifically, in the embodiments of the present disclosure, the convolutional layer computation unit 411, the quantification computation unit 412, the arithmetic encoding unit 413, the hyper-encoder 414, the quantification computation unit 415, the hyper-decoder 416, the arithmetic encoding unit 417, and the factorized prior unit 418 constitute the bitrate encoder, which optimize the rate-distortion trade-off. Secondly, the embodiments of the present disclosure effectively minimize the bitrate (transmission volume) of the data through combining the nonlinear transformation (convolution), discretization (quantification), and the entropy reduction (hyperprior arithmetic coding). Furthermore, the bitrate encoder of the present disclosure performs optimization with the downstream driving tasks. Thereby, maintaining a minimal volume is assured, and retaining critical information that is necessary for collaborative decision-making.

In addition, the multi view feature joint decoder circuit 111 corresponds to the user's vehicle, which includes the decoder 232, and the multi view feature fuser 236. The decoder 232 is configured to receive the compressed data transmitted from the driving-oriented feature encoder circuits 121, 131, and 141 to perform decompression operation on the compressed data. The decoder 232 includes: an arithmetic decoding unit 421, a factorized prior unit 422, the hyper-decoder 423, and an arithmetic decoding unit 424. The arithmetic decoding units 421, 424 are configured to perform the lossless entropy decoding to the received binary bitstream to rebuild main latent features and quantified symbols of the auxiliary information by utilizing the probability distribution provided by the entropy model. The factorized prior unit 422 is configured to provide a simplified entropy model, applied to decode the non-conditional probability distribution of the side information (hyper latent information) from the bitstream. The hyper-decoder 423 is configured to decode the hyper-prior information to generate the mean values and scales of the estimated Gaussian distribution. The aforementioned parameters can help estimating the conditional probability distribution of the main feature to let the estimation result more accurate.

The multi view feature fuser 236 is configured to fuse the driving-oriented features transmitted from the surrounding vehicles and the driving-oriented feature of the user's vehicle itself to output the fused features 237. The multi view feature fuser 236 includes: a convolutional layer computation unit 431, a Multi-head Cross-attention computation unit 432, convolutional layer computation units 433-435, an Average Pooling unit 436, a convolutional layer computation unit 437, and an adder 438. The convolutional layer computation units 431, 433-435, 437 are configured to serve as a feature extractor and an enhancer. Specifically, the convolutional layer computation unit 431 extracts partial spatial features from the vehicle itself, while the convolutional layer computation unit 433-435, 437 perform refinement to the fused feature representation to capture key driving modes. The multi-head cross-attention computation unit 432 is configured to capture a spatial correlation between the partial features of the vehicle itself and the features from networked vehicles to perform the multi view feature fusion. The average pooling unit 436 is configured to fuse multiple features from multiple networked vehicles before the fusion stage and merge into a unified feature representation. The adder 438 is configured to promote the residual connection in the feature enhancement module to ensure a stable gradient flow, and retain important spatial information during a deep feature processing procedure.

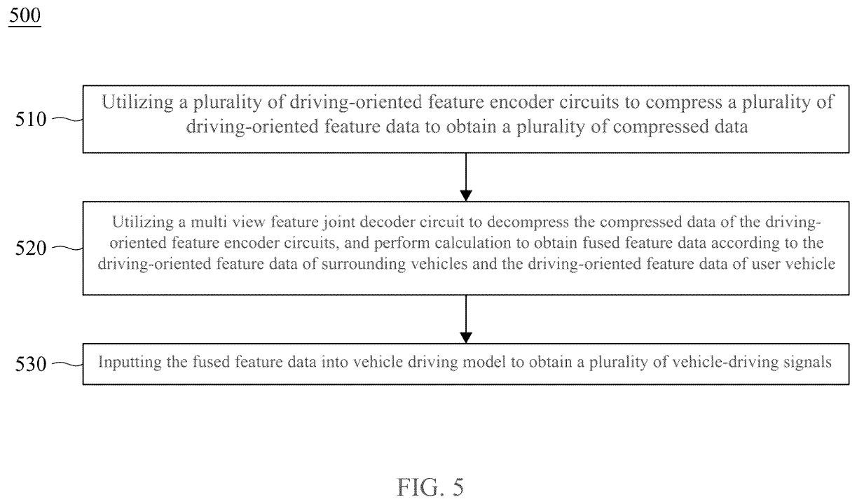

Referring to FIG. 5, FIG. 5 is a flowchart diagram of a vehicle control method 500 using collaborative driving technology, illustrated in accordance with some embodiments of the present disclosure. In process 510, utilize the driving-oriented feature encoder circuits 121, 131, and 141 mentioned above to compress the driving-oriented feature data of the surrounding vehicles to obtain multiple compressed data. In process 520, utilize the multi view feature joint decoder circuit 111 mentioned above to decompress the compressed data of the driving-oriented feature encoder circuits 121, 131, and 141, and perform calculation to obtain the fused feature data according to the driving-oriented feature data of the surrounding vehicles and the driving-oriented feature data of the user's vehicle. In process 530, inputting the fused feature data into the vehicle driving model to obtain multiple vehicle-driving signals. Thus, the throttle, brake, and steering wheel of the user's vehicle can be controlled by utilizing the vehicle-driving signals to perform the corresponding driving strategies, achieving autonomous and semi-autonomous functionalities.

The driving strategy network applied in the vehicle control system 200 using collaborative driving technology and the vehicle control method 500 using collaborative driving technology of the present disclosure is based on the BEV extraction features and performs prediction for vehicle driving operation. As a result, the vehicle control system 200 using collaborative driving technology and the vehicle control method 500 using collaborative driving technology can generate the vehicle-driving signals based on the LiDAR data. Secondly, the encoder for compressing the BEV feature data effectively compresses the BEV feature data into low dimension representation, which is suitable for wireless network environment transmission, by encoding the features into compact binary bitstream. Moreover, the multi view feature joint decoder circuit 111 can fuse the BEV feature data of the surrounding vehicles and the user's vehicle, such that the user's vehicle is able to integrate messages from multiple views, and thereby enhancing the understanding to the environment. The fused feature data is processed by the task head 238 to generate a corresponding driving strategy while considering the environmental data of the user's vehicle and the environmental data of the surrounding vehicles. Thereby, the accuracy of autonomous and semi-autonomous functionalities of the user's vehicle is enhanced.

Although the present invention has been disclosed as above, it is not intended to limit the present invention. Those with ordinary knowledge in the technical field to which the present invention belongs can make various modifications and retouching without departing from the spirit and scope of the present invention. Therefore, the scope of protection of the present invention shall be deemed as defined by the scope of the attached patent application.

What is claimed is:

1. A vehicle control system using collaborative driving technology, comprising:
a sensing device, configured to provide a plurality of sensing data of a user's vehicle;
a communication circuit, configured to receive a plurality of compressed data of a plurality of surrounding vehicles;
a control circuit, electrically connected to the sensing device and the communication circuit to receive the plurality of sensing data and the plurality of compressed data, and controlling the user's vehicle, wherein the control circuit performs:
performing a feature extraction to the plurality of sensing data to obtain a plurality of first driving-oriented features of the user's vehicle;
performing decompression to the plurality of compressed data to obtain a plurality of second driving-oriented features of the plurality of surrounding vehicles;
performing a feature fusion computation operation on the plurality of first driving-oriented features and the plurality of second driving-oriented features to obtain a plurality of fused features;
inputting the plurality of fused features into a vehicle driving model to obtain a plurality of vehicle-driving signals; and
utilizing the plurality of vehicle-driving signals to control the user's vehicle.

2. The vehicle control system using collaborative driving technology of claim 1, wherein the sensing device is a LIDAR, the plurality of sensing data represents point cloud data of a Bird's Eye View (BEV).

3. The vehicle control system using collaborative driving technology of claim 1, the plurality of vehicle-driving signals comprise a throttle control signal, a brake control signal, and a steering control signal.

4. The vehicle control system using collaborative driving technology of claim 1, wherein a loss function adopted by the vehicle driving model is shown below:
$${ℒ}_{control} = ( {ℒ}_{throttle} + {ℒ}_{ brake} + {L}_{steer} ) + λ \cdot ℛ$$
wherein [symbol] _{control} represents an overall control loss function of the user's vehicle, [symbol] ₜₕᵣₒₜₜₗₑ represents a throttle action loss function of the user's vehicle, [symbol] _{brake} represents a break action loss function of the user's vehicle, [symbol] ₛₜₑₑᵣ represents a steering action loss function of the user's vehicle, [symbol] is a bitrate, λ is a bitrate balance value.

5. A vehicle control system using collaborative driving technology, comprising:
a plurality of driving-oriented feature encoder circuits, wherein the plurality of driving-oriented feature encoder circuits correspond to a plurality of surrounding vehicles, the plurality of driving-oriented feature encoder circuits are configured to compress a plurality of driving-oriented feature data to obtain a plurality of compressed data; and
a multi view feature joint decoder circuit, wherein the multi view feature joint decoder circuit corresponds to a user's vehicle, the multi view feature joint decoder circuit is configured to decompress the plurality of compressed data of the plurality of driving-oriented feature encoder circuits, and perform calculation to obtain a fused feature data according to the plurality of compressed data; and
a control circuit, configured to receive the fused feature data, and input the fused feature data into a vehicle driving model to obtain a plurality of vehicle-driving signals;
wherein a loss function adopted by the vehicle driving model is shown below:
$${ℒ}_{control} = ( {ℒ}_{throttle} + {ℒ}_{ brake} + {L}_{steer} ) + λ \cdot ℛ$$
wherein [symbol] _{control} represents an overall control loss function of the user's vehicle, [symbol] ₜₕᵣₒₜₜₗₑ represents a throttle action loss function of the user's vehicle, [symbol] _{brake} represents a brake action loss function of the user's vehicle, [symbol] ₛₜₑₑᵣ represents a steering action loss function of the user's vehicle, [symbol] is a data bitrate corresponding to the plurality of driving-oriented feature encoder circuits, λ is a bitrate balance value.

6. The vehicle control system using collaborative driving technology of claim 5, further comprising:
a plurality of first wireless communication circuits, wherein the plurality of first wireless communication circuits correspond to the plurality of surrounding vehicles, and are electrically connected to the plurality of driving-oriented feature encoder circuits, the plurality of first wireless communication circuits are configured to receive the plurality of compressed data, and wirelessly transmit the plurality of compressed data; and
a second wireless communication circuit, wherein the second wireless communication circuit corresponds the user's vehicle, and is electrically connected to the multi view feature joint decoder circuit, the second wireless communication circuit is configured to receive the plurality of compressed data wirelessly and transmit the plurality of compressed data to the multi view feature joint decoder circuit.

7. The vehicle control system using collaborative driving technology of claim 5, wherein the plurality of vehicle-driving signals comprise a throttle control signal, a brake control signal, and a steering control signal.

8. A vehicle control method using collaborative driving technology, comprising:
utilizing a plurality of driving-oriented feature encoder circuits to compress a plurality of driving-oriented feature data to obtain a plurality of compressed data;
utilizing a multi view feature joint decoder circuit to decompress the plurality of compressed data of the plurality of driving-oriented feature encoder circuits, and performing calculation to obtain a fused feature data according to the plurality of compressed data and a sensing data;
inputting the fused feature data into a vehicle driving model to obtain a plurality of vehicle-driving signals;
wherein a loss function adopted by the vehicle driving model is shown below:
$${ℒ}_{control} = ( {ℒ}_{throttle} + {ℒ}_{ brake} + {ℒ}_{steer} ) + λ \cdot ℛ$$
wherein [symbol] _{control} represents an overall control loss function of a user's vehicle, [symbol] ₜₕᵣₒₜₜₗₑ represents a throttle action loss function of the user's vehicle, [symbol] _{brake} represents a brake action loss function of the user's vehicle, [symbol] ₛₜₑₑᵣ represents a steering action loss function of the user's vehicle, [symbol] is a data bitrate corresponding to the plurality of driving-oriented feature encoder circuits, λ is a bitrate balance value.

9. The vehicle control method using collaborative driving technology of claim 8, further comprising:
utilizing a wireless approach to transmit the plurality of compressed data from the plurality of driving-oriented feature encoder circuits to the multi view feature joint decoder circuit.

10. The vehicle control method using collaborative driving technology of claim 8, wherein the plurality of vehicle-driving signals comprise a throttle control signal, a brake control signal, and a steering control signal.

11. The vehicle control method using collaborative driving technology of claim 8, further comprising a two stage model training process to train and generate the vehicle driving model.

12. The vehicle control method using collaborative driving technology of claim 11, wherein the two stage model training process comprises a first stage model training process, the first stage model training process adopts a behavior cloning method to perform training.

13. The vehicle control method using collaborative driving technology of claim 11, wherein the two stage model training process comprises a second stage model training process, the second stage model training process adopts a Dataset Aggregation (DAgger) to perform training.

14. The vehicle control method using collaborative driving technology of claim 8, wherein the plurality of driving-oriented feature data correspond to a plurality of BEV data.

15. The vehicle control method using collaborative driving technology of claim 14, wherein the plurality of BEV data are point cloud data.
